(19) United States
(12) Patent Application Publication
(10) Pub. No.: US 2011/0274443 A1
(43) Pub. Date: Nov. 10, 2011

(54) IMAGE FORMING APPARATUS AND IMAGE FORMING METHOD

(75) Inventor: Nobuo Tohata, Shizuoka (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/040,637

(22) Filed: Mar. 4, 2011

Related U.S. Application Data
(60) Provisional application No. 61/331,142, filed on May 4, 2010.

(51) Int. Cl. G03G 15/08

(52) U.S. Cl. 399/12; 399/27

(57) ABSTRACT

An image forming apparatus includes an image forming unit including a developing device; a toner cartridge configured to supply a toner to the developing device; a toner supply agitating mechanism including a drive mechanism, and the toner supply agitating mechanism configured to agitate and to supply the toner in the toner cartridge; a load detection mechanism configured to detect a load of the drive mechanism; and an arithmetic control mechanism configured to control the drive mechanism based on the detected load, and the arithmetic control mechanism configured to execute a toner supply operation from the toner cartridge to the developing device.

### CROSS-REFERENCE TO RELATED APPLICATION

This application is based upon and claims the benefit of priority from the prior U.S. patent application No. 61/331142 filed on May 4, 2010, the entire contents of which are incorporated herein by reference.

### FIELD

Embodiments described herein relate generally to an image forming apparatus and an image forming method.

### BACKGROUND

In an image forming apparatus, when toner becomes empty, a new toner cartridge is replaced and is mounted. In the new toner cartridge, the toner often coheres in the inside of the toner cartridge due to the vibration at the time of transportation, the keeping state, thermal history and the like. When the toner coheres, since it becomes difficult to supply the toner from the toner cartridge, the cartridge is required to be mounted after the user relaxes the cohesion by manually shaking and mixing it.

However, a load is applied to the user, and when the user forgets to relax the cohesion and mounts it, the supply of toner becomes difficult. Besides, the inner pressure of the toner cartridge immediately after manual shaking and mixing is high, and there is a case where when a discharge shutter is opened at the time of mounting, the toner spouts out, and the periphery of a toner input port is soiled.

A method is conceivable in which when a new toner cartridge is detected, the inside of the toner cartridge is automatically agitated by a motor. However, when the cohesion is very high, an excessive load is applied to the motor, and the motor is damaged or breaks down.

### BRIEF DESCRIPTION OF THE DRAWINGS

FIG. 1 is a structural view of an image forming apparatus which is a four-drum tandem color printer of the first embodiment;

FIG. 2 is a schematic structural view of an image forming unit of the first embodiment;

FIG. 3 is a block diagram of a structural portion in which control of a supply operation of the first embodiment is performed;

FIG. 4 is a flowchart of supply operation control of the first embodiment;

FIG. 5 is a block diagram of a structural portion in which control of a supply operation of the second embodiment is performed;

FIG. 6 is a correspondence table of addresses and information content of a memory on a body side of the second embodiment;

FIG. 7 is a correspondence table of addresses and information content of a memory on a toner cartridge side of the second embodiment;

FIG. 8 is a flowchart of supply operation control of the second embodiment;

FIG. 9 is a correspondence table of addresses and information content of a memory on a body side of the third embodiment;

FIG. 10 is a correspondence table of addresses and information content of a memory on a toner cartridge side of the third embodiment; and

FIG. 11 is a flowchart of supply operation control of the third embodiment.

### DETAILED DESCRIPTION

Reference will now be made in detail to the present embodiment of the invention, an example of which is illustrated in the accompanying drawing.

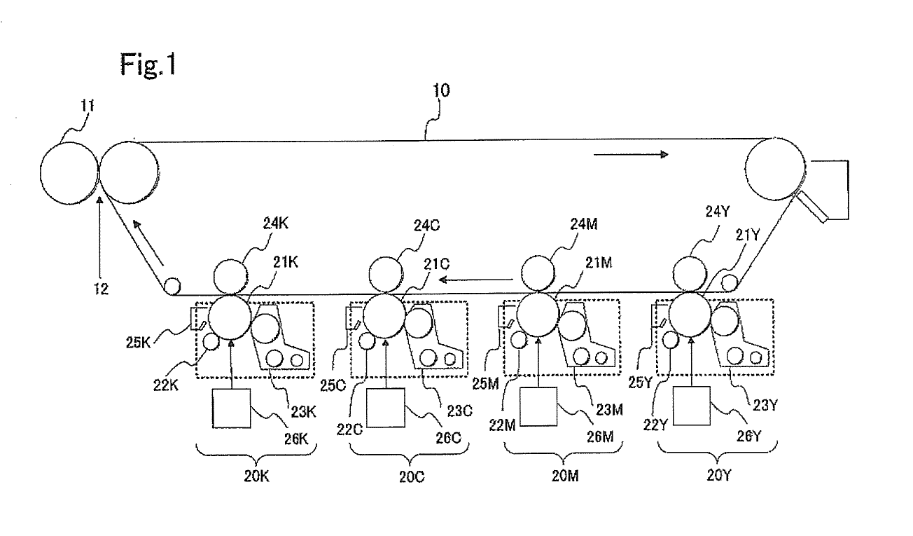

FIG. 1 is a structure view of an image forming apparatus of a four-drum tandem color printer, which is an example of an image forming apparatus (MFP) of an embodiment. As shown in FIG. 1, a secondary transfer roller 11 to transfer an image on an intermediate transfer belt 10 onto a transfer medium 12, and respective image forming units 20Y, 20M, 20C and 20K of yellow, magenta, cyan and black are arranged along the conveyance direction (arrow direction) of the intermediate transfer belt 10.

The image forming units 20Y, 20M, 20C and 20K include photoreceptors 21Y, 21M, 21C and 21K as image carriers. Further, charging devices 22Y, 22M, 22C and 22K as charging portions, developing devices 23Y, 23M, 23C and 23K including developing rollers as developing members and having developers including color toner particles of yellow, magenta, cyan and black and carrier particles, primary transfer rollers 24Y, 24M, 24C and 24K as transfer portions, and cleaner units 25Y, 25M, 25C and 25K are provided around the respective photoreceptors. These are respectively arranged along the rotation directions of the corresponding photoreceptors 21Y, 21M, 21C and 21K.

The respective primary transfer rollers 24Y, 24M, 24C and 24K are disposed inside the intermediate transfer belt 10, and nip the intermediate transfer belt 10 against the corresponding photoreceptors 21Y, 21M, 21C and 21K. Exposure devices 26Y, 26M, 26C and 26K are arranged so that exposure points are formed on the outer peripheral surfaces of the photoreceptors 21), 21M, 21C and 21K between the charging devices 22Y, 22M, 22C and 22K and the developing devices 23Y, 23M, 23C and 23K. The secondary transfer roller 11 is arranged outside the intermediate transfer belt 10 so as to contact therewith.

A print operation is performed as described below by the image forming apparatus constructed as stated above. A toner image is formed in the image forming unit 20Y. The same process is performed also in the image forming units 20M, 20C and 20K in synchronization with the timing of the toner image formation in the image forming unit 20Y. The toner images of magenta, cyan and black formed on the photoreceptors of the image forming units 20M, 20C and 20K are also sequentially primarily transferred onto the intermediate transfer belt 10.

The transfer medium 12 is conveyed from a cassette (not shown), and is sent to the intermediate transfer belt 10 by an aligning roller (not shown) in timing with the toner images on the intermediate transfer belt 10.

A bias (+) of a reverse polarity to a charging polarity of a toner is applied to the secondary transfer roller 11 by a power source (not shown). As a result, the toner images on the intermediate transfer belt 10 are transferred onto the transfer medium 12 by a secondary transfer voltage applied between the intermediate transfer belt 10 and the secondary transfer roller 11. A fixing device to fix the toner transferred onto the transfer medium 12 is disposed, and the transfer medium 12 is made to pass through the fixing device (not shown) so that a fixed image is obtained.

Incidentally, although the description is made on the example in which the image forming units are arranged in color sequence of yellow, magenta, cyan and black, the color sequence is not limited.

Hereinafter, details of the image forming apparatus of the embodiment will be described.

Embodiment 1

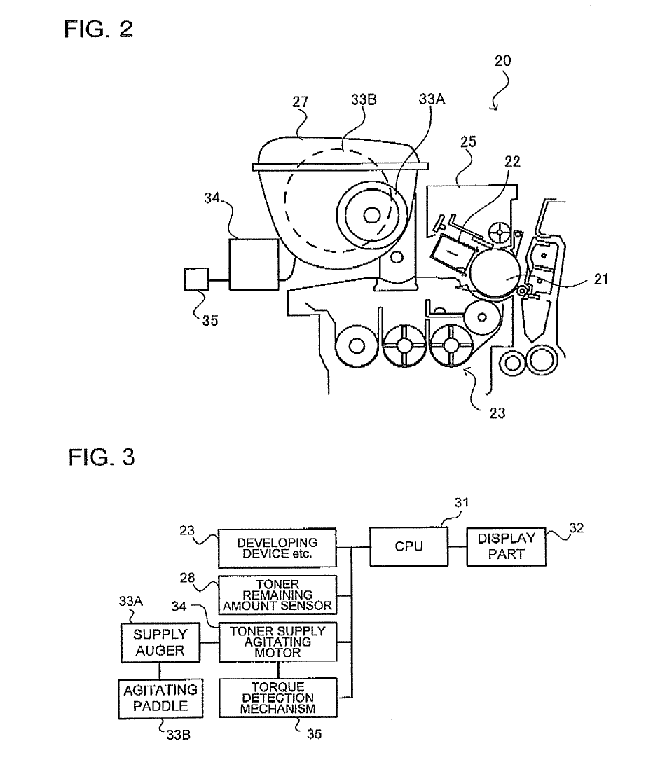

FIG. 2 is a schematic structural view of an image forming unit 20 of the image forming apparatus of this embodiment.

As shown in FIG. 2, a charging device 22, a developing device 23 and a cleaner unit 25 are arranged around a photoreceptor 21. A toner cartridge 27 is mounted to the developing device 23. A toner remaining amount sensor 28 is provided in the image forming apparatus (body). A supply auger 33A and an agitating paddle 33B are provided in the toner cartridge 27 and are connected to a toner supply agitating motor 34 as a drive mechanism to drive these. Further, the toner supply agitating motor 34 is connected to a torque detection mechanism 35 to measure motor load (torque) by detection of a current value or the like.

In the image forming unit as stated above, cohesion of toner is relaxed, and a supply operation is performed as described below. FIG. 3 is a block diagram of a structural portion in which the control of the supply operation is performed. As shown in FIG. 3, a CPU 31 as an arithmetic control mechanism is connected to the respective components, such as the developing device 23, of the image forming unit, the toner remaining amount sensor 28, the toner supply agitating motor 34, and a display part 32 to display an instruction to a user.

The toner supply agitating motor 34 is connected to the agitating paddle 33B through the supply auger 33A, and a toner supply agitating mechanism is constructed. Further, the torque detection mechanism 35 is connected.

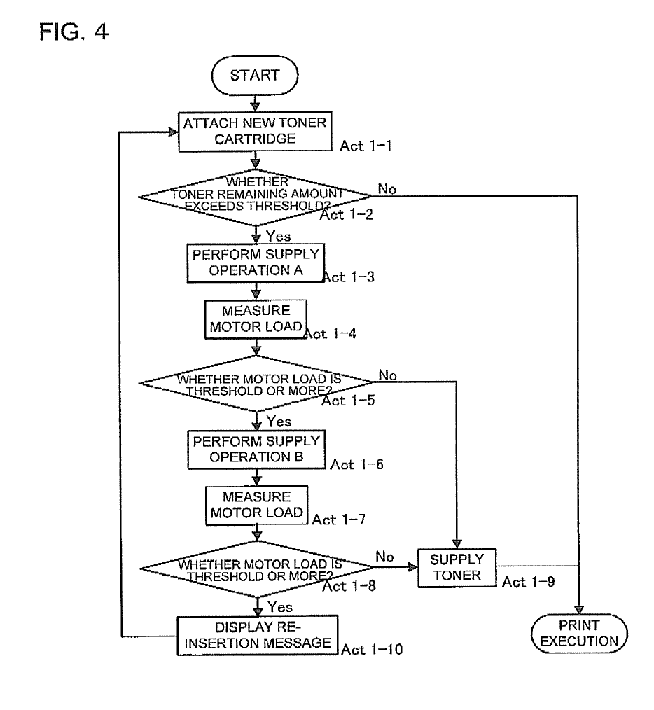

By the structure as stated above, in the image forming unit, the control of the supply operation is performed as described below. FIG. 4 is a flowchart. As shown in FIG. 4, a front cover is opened, and a new toner cartridge is attached (Act 1-1).

It is determined whether a toner remaining amount detected by the toner remaining amount sensor 28 exceeds a threshold representing an empty state (Act 1-2). When the toner remaining amount exceeds the threshold, it is determined that the empty state occurs, and a supply operation A is performed (Act 1-3). When the toner remaining amount is the threshold or less, print execution is placed in a ready state.

In the supply operation A, for example, a normal working voltage of 24.0 V is applied to the toner supply agitating motor 34 for 3 sec, and the torque detection mechanism 35 measures motor load at 3 sec (Act 1-4).

It is determined whether the measured motor load is the threshold or more (Act 1-5). At this time, the motor load (motor generation current) A [A] and the torque M [kgfcm] have a relation of

M=A×1.667,

and the determination may be made based on the value of the torque. At this time, the threshold may be inputted in a memory provided in the image forming apparatus.

When the threshold is, for example, 0.9 A, when the motor load is less than 0.9 A, it is determined that cohesion of toner is low, and the agitating paddle 33B operates without problem, and the print execution is placed in the ready state. When the motor load is 0.9 A or more, a supply operation B is performed (Act 1-6).

In the supply operation B, for example, after 24.0 V is applied to the toner supply agitating motor 34 for 1 sec, it is turned OFF for 2 sec, and this is repeated by 10 sets. Further, 24.0 V is applied for 3 sec, and the torque detection mechanism again measures the motor load at 3 sec (Act 1-7).

It is determined whether the measured motor load is the threshold or more (Act 1-8). When the motor load is less than 0.9 A, it is determined that cohesion of toner is relaxed and the agitating paddle 33B operates without problem, and after the toner supply (Act 1-9) is completed, the state of print ready occurs, and printing is performed.

When the motor load is 0.9 A or more, it is determined that cohesion of toner is very high, and a message of “Please shake the toner cartridge and again insert.” is displayed on an operation panel as a display part (Act 1-10), and the toner cartridge is removed.

In this way, the load is applied to the toner supply agitating motor for the short time plural times when necessary, so that the motor load is suppressed, the cohesion is relaxed without damaging or breaking the motor, and the supply operation can be performed.

Embodiment 2

In this embodiment, a memory such as an IC chip is provided in each of an image forming apparatus (image forming unit) and a toner cartridge, and a supply operation is performed according to the characteristic of stored toner.

The image forming unit in the image forming apparatus of this embodiment is the same as that of embodiment 1, and in addition to the structure shown in FIG. 2, a memory is provided in each of the image forming unit (body) 20 and the toner cartridge 27.

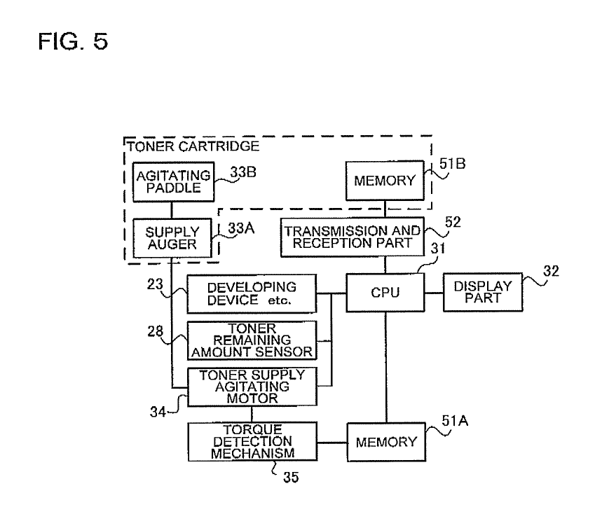

In the image forming unit as stated above, cohesion of toner is relaxed as described below, and a supply operation is performed. FIG. 5 is a block diagram of a structural portion in which the control of the supply operation is performed. As shown in FIG. 5, similarly to embodiment 1, a CPU 31 as an arithmetic control mechanism is connected to respective components, such as a developing device 23, of the image forming unit, a toner remaining amount sensor 28, a toner supply agitating motor 34 and a display part 32 to display an instruction to a user. The toner supply agitating motor 34 is connected to an agitating paddle 33B through a supply auger 33A, and a toner supply agitating mechanism is constructed.

In this embodiment, the CPU 31 is further connected to a memory 51A on the image forming unit (body) 20 side and is connected to a memory 51B on the toner cartridge 27 side through a transmission and reception part 52.

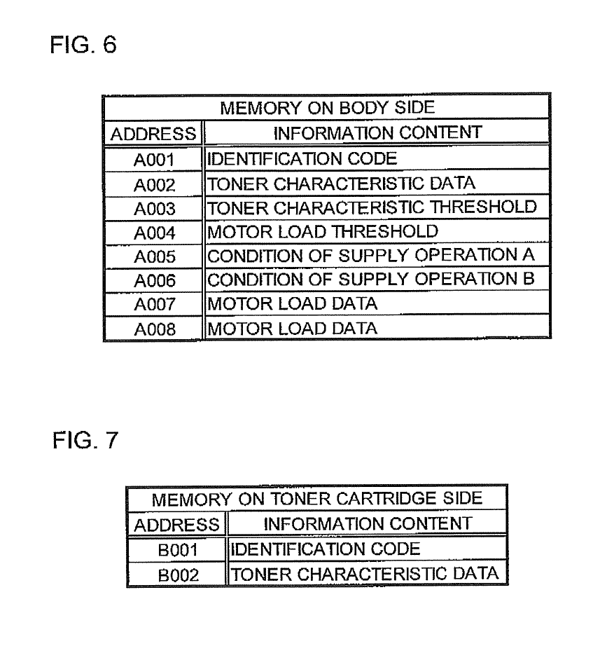

FIG. 6 shows a correspondence table of addresses and information content of the memory 51A on the body side, and FIG. 7 shows a correspondence table of addresses and information content of the memory 51B on the toner cartridge side.

As shown in the table of FIG. 6, the memory 51A on the body side includes, for the respective addresses, an area (A001) in which an identification code is inputted, an area (A002) in which after-mentioned toner characteristic data from the memory 51B is written, an area (A003) in which a threshold of toner characteristic is inputted, an area (A004) in which a threshold of motor load is inputted, an area (A005) in which a condition of supply operation A is inputted, an area (A006) in which a condition of supply operation B is inputted, and areas (A007, A008) in which measured motor loads are written.

As shown in the table of FIG. 7, the memory 51B on the toner cartridge side includes, for the respective addresses, an area (B001) in which an identification code is inputted, and an area (B002) in which the toner characteristic data, such as Tg of toner, is inputted. Incidentally, the toner characteristic data is arbitrary as long as the characteristic has an influence on cohesion of toner, and a preservation property may be used. The preservation property is evaluated by the easiness of cohesion of toner obtained by a following measuring method.

Measuring method of the preservation property

(1) After a toner of 20g is inputted in a polyethylene bottle of 100 cc, a cover is put, and it is heated for 8 hours in a water tank of 50° C.

(2) The bottle is taken out from the water tank, and is left for 8 hours in a warm room.

(3) The toner after heating is put on a 42 mesh sieve, and sieving is performed while vibration is applied by a power tester made by Hosokawa Micron Corporation,

(4) The amount of toner on the sieve is measured.

The measured amount of toner indicates that as the amount becomes large, cohesion occurs more easily.

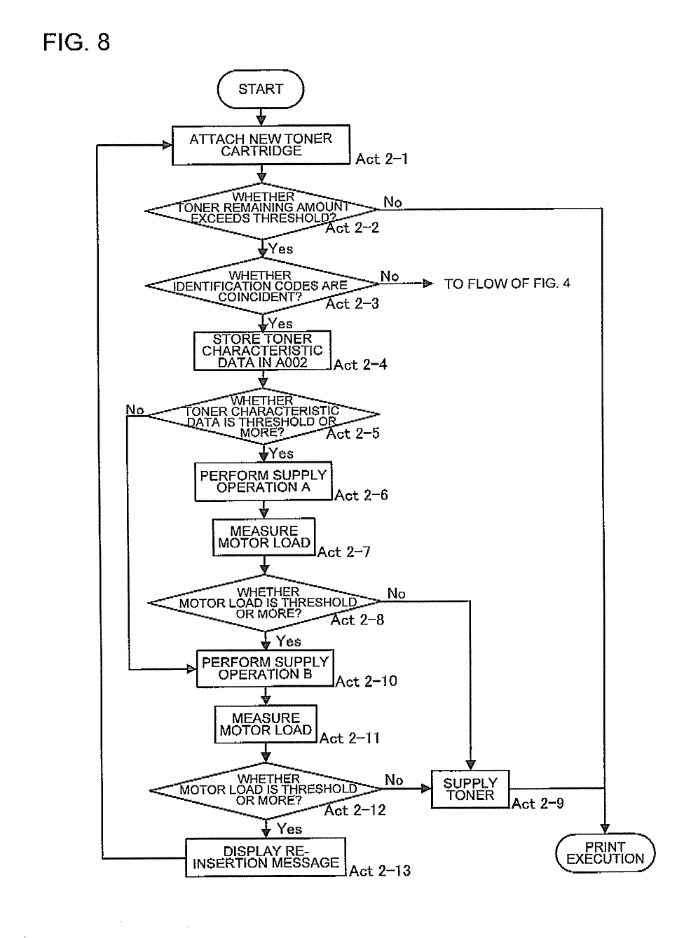

By the structure as stated above, in the image forming unit, the control of the supply operation is performed as described below. FIG. 8 is a flowchart. As shown in FIG. 8, a front cover is opened, and a new toner cartridge is attached (Act 2-1).

It is determined whether the toner remaining amount detected by the toner remaining amount sensor 28 exceeds a threshold representing an empty state (Act 2-2). When the toner remaining amount exceeds the threshold, it is determined whether the identification codes inputted in A001 of the memory 51A and B001 of the memory 51B are coincident with each other (Act 2-3).

When the identification codes are coincident, the toner characteristic data Tg of B002 is stored in A002 of the memory 51A (Act 2-4). When they are not coincident, the toner cartridge is replaced, or the control of supply operation is performed based on the flow shown in FIG. 4 of embodiment 1.

It is determined whether Tg of A002 is the threshold of A003 or more (Act 2-5). When the threshold of A003 is, for example, Tg=53° C., when Tg is less than 53° C., it is determined that cohesion is high, and the after-mentioned supply operation B of A006 is performed (Act 2-10).

When Tg of A002 is 53° C. or more, it is determined that cohesion is low, and similarly to embodiment 1, the supply operation A (24.0V/3 sec) of A005 is performed by the toner supply agitating motor 34 (Act 2-6), and the motor load at 3 sec is measured by the torque detection mechanism 35 (Act 2-7) and is written in A007.

It is determined whether the motor load of A007 is the threshold of A004 or more (Act 2-8). When the threshold is, for example, 0.9 A similarly to embodiment 1, when the motor load is less than 0.9 A, it is determined that cohesion of toner is low, and the agitating paddle 33B operates without problem. After the toner supply (Act 2-9) is completed, print execution is placed in the ready state, and printing is performed.

When the motor load is 0.9 A or more, similarly to embodiment 1, the supply operation B ([24.0V/3 sec+2 sec OFF]*10 sets+24.0V/3sec) of A006 is performed (Act 2-10) by the toner supply agitating motor 34, and the motor load at the last 3 sec is again measured by the torque detection mechanism 35 (Act 2-11), and is written in A008.

It is determined whether the motor load of A008 is the threshold of A004 or more (Act 2-12). When the motor load is less than 0.9 A, it is determined that cohesion of toner is relaxed, and the agitating paddle 33B operates without problem. After the toner supply (Act 2-9) is completed, the state of print ready occurs, and printing is performed.

When the motor load is 0.9 A or more, it is determined that cohesion of toner is very high, and a message of “Please shake the toner cartridge and again insert.” is displayed on the operation panel as the display part (Act 2-13), and the toner cartridge is removed.

In this way, the toner characteristic for determining the easiness of cohesion is previously inputted in the memory on the toner cartridge side, and based on that, the load is more appropriately applied to the toner supply agitating motor for the short time plural times when necessary. Thus, the motor load is suppressed, the cohesion is relaxed without damaging or breaking the motor, and the supply operation can be performed.

Embodiment 3

In this embodiment, similarly to embodiment 2, a memory such as an IC chip is provided in each of an image forming apparatus (image forming unit) and a toner cartridge, and a supply operation is performed according to the history of stored toner.

The image forming unit in the image forming apparatus of this embodiment is the same as that of embodiment 1, and in addition to the structure shown in FIG. 2, a memory is provided in each of the image forming unit (body) 20 and the toner cartridge 27.

In the image forming unit as stated above, cohesion of toner is relaxed and the supply operation is performed as described below. Although a structural portion in which the control of the supply operation is performed is the same as FIG. 5 of embodiment 2, the content written in the memory 51A on the body side and the memory 51B on the toner cartridge 27 side are different.

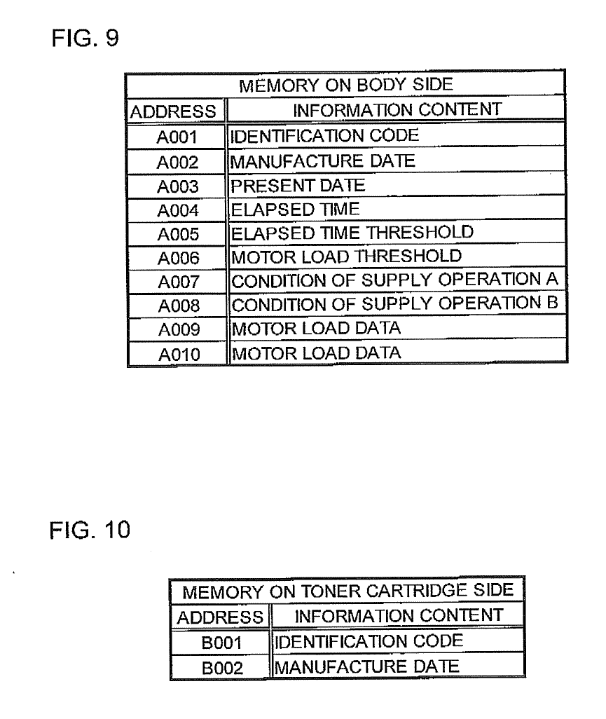

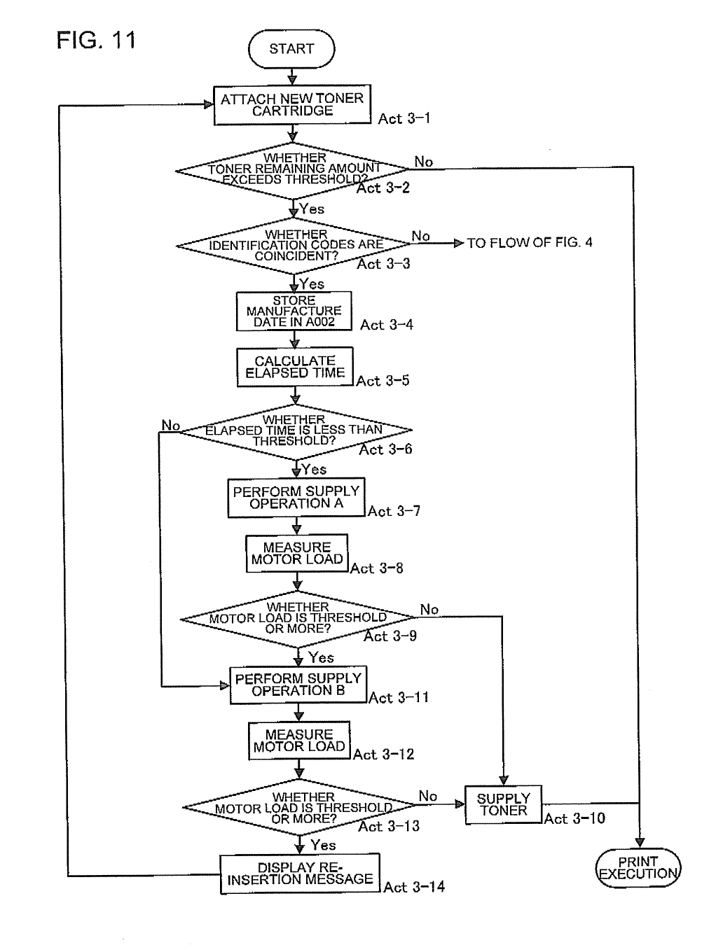

FIG. 9 shows a correspondence table of addresses and information content of the memory 51A on the body side, and FIG. 10 shows a correspondence table of addresses and information content of the memory 51B on the toner cartridge side.

As shown in the table of FIG. 9, the memory 51A on the body side includes, for respective addresses, an area (A001) in which an identification code is inputted, an area (A002) in which an after-mentioned manufacture date (toner filling date) of the toner cartridge from the memory 51B is written, an area (A003) in which a present date is written, an area (A004) in which an elapsed time is written, an area (A005) in which a threshold of the elapsed time is inputted, an area (A006) in which a threshold of motor load is inputted, an area (A007) in which a condition of a supply operation A is inputted, an area (A008) in which a condition of a supply operation 8 is inputted, and areas (A009, A010) in which measured motor loads are written.

As shown in the table of FIG. 10, the memory 51B on the toner cartridge side includes, for respective addresses, an area (B001) in which an identification code is inputted, and an area (B002) in which the manufacture date (toner filling date) of the toner cartridge is inputted.

Incidentally, the data inputted here may be any history having an influence on cohesion of toner, and in addition to the manufacture date, for example, a vibration history during transportation or by user's shaking, which is obtained by using a vibration sensor or the like and by detecting vibration of a certain intensity or higher, an inclination history during transportation or during storage, the presence or absence of passage through a specified period (for example, summary), and the like can be used.

By the structure as stated above, in the image forming unit, the control of the supply operation is performed as described below. FIG. 11 is a flowchart. As shown in FIG. 11, a front cover is opened, and a new toner cartridge is attached (Act 3-1).

It is determined whether the toner remaining amount detected by the toner remaining amount sensor 28 exceeds a threshold representing an empty state (Act 3-2). When the toner remaining amount exceeds the threshold, it is determined whether the identification codes inputted in A001 of the memory 51A and B001 of the memory 51B are coincident with each other (Act 3-3).

When the identification codes are coincident, the manufacture date of B002 is stored in A002 of the memory 51A (Act 3-4). When they are not coincident, the toner cartridge is replaced, or the control of the supply operation is performed based on the flow shown in FIG. 4 of embodiment 1.

The elapsed time is obtained from a difference between the manufacture date written in A002 and the present date of A003, and is written in A004 (Act 3-5). It is determined whether the elapsed time of A004 is less than the threshold of A005 (Act 3-6). When the threshold of A005 is, for example, 300 days, when the elapsed time is less than 300 days, it is determined that cohesion is low. Similarly to embodiment 1, the supply operation A (24.0V/3sec) of A007 is performed by the toner supply agitating motor 34 (Act 3-7), and the motor load at 3 sec is measured by the torque detection mechanism 35 (Act 3-8) and is written in A009.

When the elapsed time is 300 days or more, it is determined that cohesion is high, and the supply operation B of A008 is performed by the toner supply agitating motor (Act 3-11).

It is determined whether the motor load of A009 is the threshold of A006 or more (Act 3-9). When the threshold is, for example, 0.9 A similarly to embodiment 1, when the motor load is less than 0.9 A, it is determined that cohesion of toner is low and the agitating paddle 33B operates without problem. After the toner supply (Act 3-10) is completed, print execution is placed in the ready state, and printing is performed.

When the motor load is 0.9 A or more, similarly to embodiment 1, the supply operation B (([24.0V/3 sec+2 sec OFF]+10 sets+24.0V/3 sec) of A008 is performed by the toner supply agitating motor 34 (Act 3-11), and the motor load at the last 3 sec is again measured by the torque detection mechanism 35 (Act 3-12) and is written in A009.

It is determined whether the motor load of A010 is the threshold of A006 or more (Act 3-13). When the motor load is less than 0.9 A, it is determined that cohesion of toner is relaxed and the agitating paddle 33B operates without problem. After the toner supply (Act 3-12) is completed, the state of the print ready occurs, and printing is performed.

When the motor torque is 0.9 A or more, it is determined that cohesion of toner is very high, and a message of “Please shake the toner cartridge and again inert” is displayed on the operation panel as the display part (Act 2-14), and the toner cartridge is removed.

In this way, the toner history for determining the easiness of cohesion is previously inputted in the memory on the toner cartridge side, and based on that, the load is more appropriately applied to the toner supply agitating motor for the short time plural times when necessary. Thus, the motor load is suppressed, the cohesion is relaxed without damaging or breaking the motor, and the supply operation can be performed.

While certain embodiments have been described, these embodiments have been presented by way of example only, and are not intended to limit the scope of the inventions. Indeed, the novel embodiments described herein may be embodied in a variety of other forms; furthermore, various omission, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image forming unit including a developing device;
a toner cartridge configured to supply a toner to the developing device;
a toner supply agitating mechanism including a drive mechanism, and the toner supply agitating mechanism configured to agitate and to supply the toner in the toner cartridge;
a load detection mechanism configured to detect a load of the drive mechanism; and
an arithmetic control mechanism configured to control the drive mechanism based on the detected load, and the arithmetic control mechanism configured to execute a toner supply operation from the toner cartridge to the developing device.

2. The apparatus of claim 1, wherein the image forming unit includes a first memory in which a threshold of the detected load is inputted.

3. The apparatus of claim 2, wherein the first memory includes an area in which the detected load is written.

4. The apparatus of claim 2, wherein a condition of the toner supply operation selected based on the load is inputted in the first memory.

5. The apparatus of claim 1, wherein the load is one of a current value and a torque.

6. The apparatus of claim 1, further comprising a second memory which is provided incidental to the toner cartridge, and in which at least one of a characteristic and a history of the stored toner is inputted.

7. The apparatus of claim 6, wherein the characteristic of the toner is at least one of Tg of the toner and a preservation property.

8. The apparatus of claim 6, wherein the history of the toner is at least one of a manufacture date of the toner cartridge, a vibration history, an inclination history, and presence or absence of passage through a specified period.

9. The apparatus of claim 6, further comprising a transmission and reception part to connect the arithmetic control mechanism and the second memory via wired or wireless.

10. The apparatus of claim 2, wherein a threshold of at least one of a characteristic and a history of the toner is inputted in the first memory.

11. The apparatus of claim 10, wherein the first memory includes an area in which at least one of the characteristic and the history of the toner is written.

12. The apparatus of claim 10, wherein a condition of the toner supply operation selected based on at least one of the characteristic and the history of the toner is inputted in the first memory.

13. An image forming method comprising:
attaching a new toner cartridge into an image forming unit;
detecting a load of a drive mechanism when a toner in the toner cartridge is agitated using the drive mechanism; and
controlling the drive mechanism based on the detected load and performing a toner supply operation.

14. The method of claim 13, further comprising;
determining whether the load is a previously inputted threshold of the load or more, and
controlling the drive mechanism based on the determination.

15. The method of claim 13, wherein the load is a current value or a torque.

16. The method of claim 13, further comprising;
determining whether at least one of a previously inputted characteristic and a history of the toner is at least one of previously inputted thresholds of the characteristic and the history of the toner or more;
controlling the drive mechanism based on the determination.

17. The method of claim 13, wherein the characteristic of the toner is at least one of Tg of the toner and a preservation property.

18. The method of claim 16, wherein the history of the toner is at least one of a manufacture date of the toner cartridge, a vibration history, an inclination history, and presence or absence of passage through a specified period.

19. The method of claim 13, wherein cohesion of the toner is relaxed by the toner supply operation.

20. The method of claim 19, wherein after the cohesion of the toner is relaxed, printing is performed.
